(19) United States
(12) Patent Application Publication
(10) Pub. No.: US 2012/0085955 A1
(43) Pub. Date: Apr. 12, 2012

(54) WATER VALVE

(76) Inventor: Jong Koo Kim, Incheon (KR)

(21) Appl. No.: 13/125,309

(22) PCT Filed: Jul. 7, 2009
(86) PCT No.: PCT/KR09/03708

§ 371 Date: Dec. 5, 2011

(30) Foreign Application Priority Data
Oct. 20, 2008 (KR) 10-2008-0102618

(51) Int. Cl. F16K 21/00

(52) U.S. Cl. 251/286

(57) ABSTRACT

The present invention relates to a water valve. More particularly, the present invention relates to a water valve having a valve cartridge for controlling the temperature and flow of supplied hot/cold water, wherein a discharge path is blocked, or a direct water path or a shower path is selected and the amount of water flow is controlled, by changing the direction of rotation in a flow control section. The present invention can exert various functions through a simple structure and operation, as the water valve can be turned on or off, a direct water path or a shower path can be selected, and the flow of the selected path can be controlled, through manipulation of a flow control unit. In addition, the present invention has a simple structure and is easily installed by combining a water valve and a nozzle head.

### TECHNICAL FIELD

The present invention relates to a water valve.

### BACKGROUND ART

In general, the water valve is an adjusting valve for supply of tap water which is adapted to adjust amount of the tap water (including hot water supplied through boiler) supplied form the outside and select cold water or hot water or mix them to adjust water temperature.

The water valve is installed on a upper part of sink in kitchen or in bathroom (including bathhouse), and enables use of the water through operation as necessary.

As such a water valve, there are a rotary-type water valve in which adjusting of water amount and selection of the cold/hot water or mixing of the water and thereby adjusting of the water temperature is carried out by turning of a knob, and lever-type water valve in which the water amount is adjusted by raising or lowering of the lever and selection of the cold/hot water or mixing of the water and thereby adjusting water temperature is carried out by rightward or leftward turning of the lever.

At this point, in case of the rotary-type water valve, a valve cartridge is included in the valve, which adjusts the amount and the temperature of the supplied cold/hot water to discharge it, and regarding the operation of the valve cartridge, depending on the degree of alignment of a cold/hot water hole of separation/introduction disk, which separates the cold/hot water to introduce it, and a mixing hole of water temperature-adjusting disk, which can be rotationally operated rightward and leftward while being brought into contact with the separation/introduction disk, the cold water or the hot water is discharged or mixing of both of them is established (adjusting of water temperature), and an opened area of the mixing hole is adjusted by rotational operation of an opening and closing disk, and thus discharge amount (flow amount) is adjusted.

### DISCLOSURE OF THE INVENTION

### Problem to be Solved by the Invention

However, in case of the prior rotary-type water valve as described above, it is not impossible to realize functions of water valve for adjusting the water temperature and the flow amount, but in social condition pursuing multi-functions as in recent years. a water valve is required which exhibits another functions other than basic functions.

In addition, a water valve is required whose structure is not complex and whose volume is not large while exhibiting multi-functions as described above.

### Means for Solving the Problem

The present invention is characterized in that in a water valve comprising a valve cartridge which adjusts amount and temperature of supplied cold/hot water so as to discharge it, blocking of a discharge path, selecting of a direct water path or a shower path and adjusting of flow amount are established through operation of changing rotation direction carried out in a flow control section.

### Advantageous Effects

In the present invention, the selection of the direct water path or the shower path or the adjustment of the flow amount of the selected path as well as the opening and closing operation can be made only through the operation of the flow amount-adjusting member (160), thereby the realization of various functions is possible with simple structure and operations.

Furthermore, in the present invention, the water valve (10) and the injection port head are integrated, thereby the structure is simple and the installation can be treated simply.

### BRIEF DESCRIPTION OF THE DRAWING

FIG. 1 is a perspective view illustrating external constructions according to an example of the present invention.

FIG. 2 is a sectional view illustrating details of constructions according to an example of the present invention.

FIG. 3 is a exploded perspective view illustrating constructions of a valve cartridge according to an example of the present invention.

FIGS. 4 to 6 are plane views illustrating selection and mixed state of the cold/hot water by co-operation of a separation/introduction disk and a selection/mixing disk of the present invention.

FIGS. 7 to 9 are plane views illustrating blocking of discharge, selection of path and adjusted state of opened and closed area of a selected path by co-operation of a discharge disk and a blocking/path selection disk of the present invention.

<LISTS OF REFERNECE NUMERALS IN THE DRAWINGS>

| | | | |
|---|---|---|---|
| 10: | water valve | 11: | valve body |
| 12: | outlet port | 12a: | direct water hole |
| 12b: | shower hole | 100: | water valve cartridge |
| 110: | cartridge base | 120: | separation/introduction |
| | | | disk |
| 121: | cold water hole | 122: | hot water hole |
| 130: | selection/mixing disk | 131: | selection hole |
| 132: | mixing hole | 133: | projected portion |
| 140: | discharge disk | 141: | discharge hole |
| 150: | blocking/path selection disk | 151: | direct water guide hole |
| 152: | shower path guide hole | 153: | fitting hole |
| 160: | flow amount-adjusting | 161: | direct water path |
| | member | | |
| 162: | shower path | 163: | shower discharge hole |
| 164: | stopper | 165: | projected piece |
| 170: | water temperature-adjusting | | |
| | member | | |
| 171: | lateral extension piece | | |
| 172: | fitting projected portion | 180: | blocking bush |
| 181: | fixing projection | 182: | fixing projected portion |
| 190: | cartridge housing | 191: | fixing projected piece |
| 1: | flow amount-adjusting knob | | |
| 2: | water temperature-adjusting | | |
| | knob | | |

### BEST MODE FOR CARRYING OUT THE INVENTION

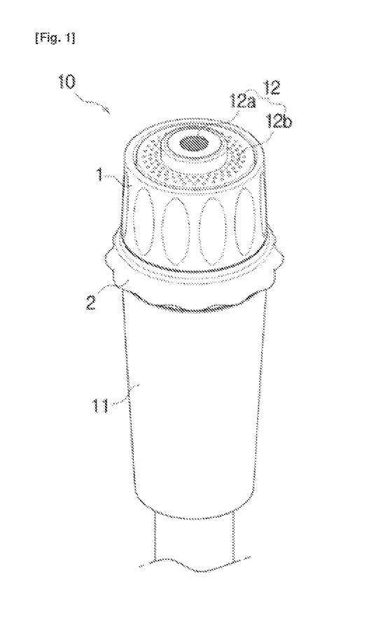

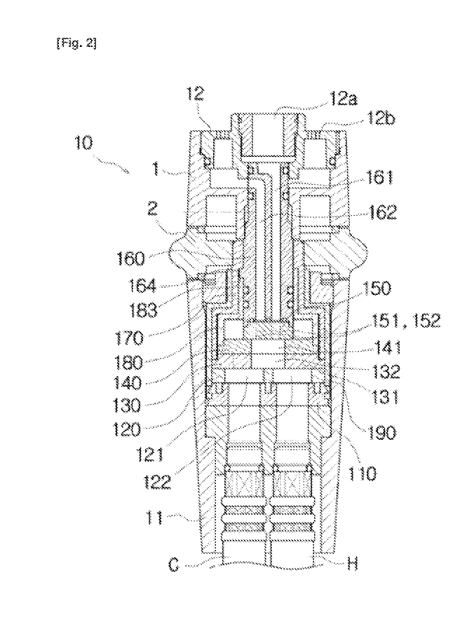

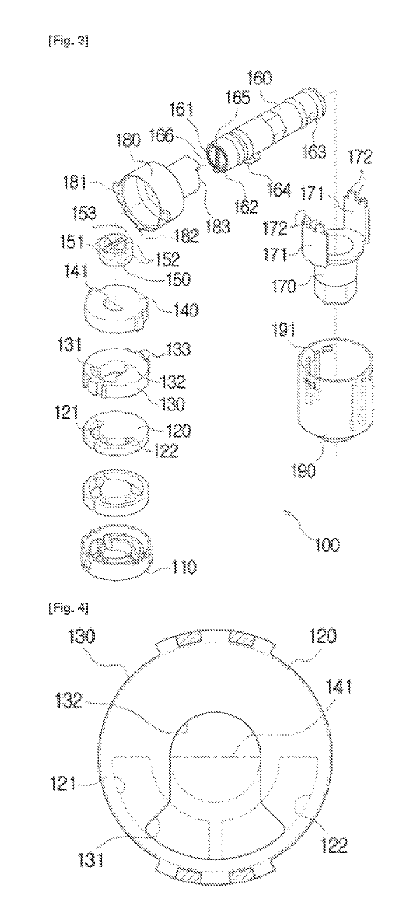

In the attached drawings presented to facilitate the understanding of the present invention prior to description of it, FIG. 1 is a perspective view illustrating external constructions according to an example of the present invention, FIG. 2 is a sectional view illustrating details of constructions according to an example of the present invention, FIG. 3 is a exploded perspective view illustrating constructions of a valve cartridge according to an example of the present invention, FIGS. 4 to 6 are plane views illustrating selection and mixed state of the cold/hot water by co-operation of a separation/introduction disk and a selection/mixing disk of the present invention, and FIGS. 7 to 9 are plane views illustrating blocking of discharge, selection of path and adjusted state of opened and closed area of a selected path by co-operation of a discharge disk and a blocking/path selection disk of the present invention, and reference numeral “10” in the drawings indicates a water valve as the subject matter of the present invention, and reference numeral “100” indicates a valve cartridge as a main part of the present invention.

The present invention will be described with reference to the attached drawings presented as above.

First, in the water valve of the present invention comprising a valve cartridge (100) which adjusts amount and temperature of supplied cold/hot water so as to discharge it, blocking of a discharge path, selecting of a direct water path or a shower path and adjusting of flow amount are established through operation of changing rotation direction carried out in a flow control section, as illustrated in FIGS. 1 to 3 in the attached drawings.

Here, the valve cartridge (100) of the present invention comprises a separation/introduction disk (120) for separating and introducing the cold/hot water; a selection/mixing disk (130) which is stacked on one side face of the separation/introduction disk (120) and selects and mixes the cold/hot water through rightward and leftward rotational operation; a discharge disk (140) which is stacked on one side face of the selection/mixing disk (130) and guides water introduced from the selection/mixing disk (130) in a discharge direction; a blocking/path selection disk (150) which is stacked on one side face of the discharge disk (140) and blocks the discharge of the water or guides the water to a direct water path or a shower path througt the rightward and leftward rotational operation; a flow amount-adjusting member (160), one end portion of which is fastened to one side face of the blocking/path selection disk (150) and the other end portion of which is exposed to the outside, and to the exposed circumferential surface of which is fastened a flow amount-adjusting knob (1), so that the water is discharged directly or in a shower only in a state that the blocking/path selection disk (150) is opened by rotational operation of the flow amount-adjusting knob (1); a water temperature-adjusting member (170), one end portion of which is fastened to one side face of the selection/mixing disk (130) and the other end portion of which is exposed to the outside, and to the exposed circumferential surface of which is fastened a water temperature-adjusting knob (2), so that the selection/mixing disk (130) is rotated by rotational operation of the water temperature-adjusting knob (2); a blocking bush (180), one end portion of which is fastened to one side face of the discharge disk (140) to form a sealed space, and the other end portion of which is brought into close contact with a circumferential surface of one end portion of the flow amount-adjusting member (160) to limit a rotation angle of the flow amount-adjusting member (160); a cartridge base (110) which accommodates the separation/introduction disk (120) to prevent rotational play; and a cartridge housing (190) which is fastened to the cartridge base (110) to accommodate all the components described above, and limits rotation angle of the water temperature-adjusting member (170).

At this point, the flow amount-adjusting knob (1) is fitted on the outer circumferential surface of the flow amount-adjusting member (160) with the inner circumferential surface of the knob being in a angled state, and the water temperature-adjusting knob (2) is also fitted on the outer circumferential surface of the water temperature-adjusting member (170) with the inner circumferential surface of the knob being in a angled state. Here, “being fitted in a angled state” is a conventional structure wherein the outer circumferential surface is formed in a polygonal form and the inner circumferential surface is formed in a corresponding polygonal form, thereby idle in rotation does not occur.

In addition, here, the flow control section may be part which the discharge disk (140) and the blocking/path selection disk (150) adjoin, the discharge disk guiding the introduced water in the discharge direction, and the blocking/path selection disk being stacked on one side face of the discharge disk (140) and blocking the discharge of the water or guiding the water to the direct water path or the shower path through the rightward and leftward rotational operation.

In addition, here, the valve cartridge (100) is inserted and fixed inside a valve body (11) connected with cold/hot water pipes (C)(H) such that only end portions of the flow amount-adjusting member (160) and the water temperature-adjusting member (170) are exposed to the outside, and the end portions of the flow amount-adjusting member (160) exposed to the outside can be assembled with an outlet port (12) for discharging the water being discharged to a direct water hole (12a) in central portion or a shower hole (12b) in outer side portion.

At this point, the central portion of the outlet port (12) may be fitted with end portion of the flow amount-adjusting member (160), and the outer circumferential surface of the outlet port may be fixed by screwing to the inner surface of one end portion of the flow amount-adjusting knob (1).

Furthermore, the flow amount-adjusting knob (1) and the water temperature-adjusting knob (2) may be arranged in the form of ring between the valve body (11) and the outlet port (12).

Meanwhile, the separation/introduction disk (120) of the present invention is a circular plate-like disk, one side face of which is partially accommodated in the cartridge base (110) to be fixed therein, and arc-like cold/hot water holes (121)(122) may be provided symmetrically in the half parts of the separation/introduction disk, respectively.

At this point, the arc-like cold/hot water holes (121)(122) may be formed in the range of 180 degrees of angle.

Furthermore, the selection/mixing disk (130) of the present invention is a circular plate-like disk which is brought into close contact with one side face of the separation/introduction disk (120), and comprises a selection hole (131) formed in the central part and a arc-like mixing hole (132) having arc-angle of 90 degrees which is formed by outward extension from the selection hole (131), and a plurality of projected portions (133) which are projected on the both sides of the outer circumferential surface of the disk to define grooves, thus fasten the disk on one end portion of the water temperature-adjusting member (170).

At this point, the mixing hole (132) may have the same opening area as that of the cold water hole (121) or hot water hole (122) of the separation/introduction disk (120).

The selection/mixing disk (130) as constructed above may be rotated rightward or leftward in 180 degrees of angle so that the selection hole (131) may communicate with the cold water hole (121) or the hot water hole (122) of the separation/introduction disk (120), or both of them.

In this way, the cold water or the hot water or both of them may be mixed and adjusted to a desired water temperature, and the water is introduced to the mixing hole (132) in the central portion in such a communication state as described above.

Furthermore, the discharge disk (140) is a circular plate-like disk which is brought into close contact with one side face of the selection/mixing disk (130) and a part of the outer circumferential surface of which is fitted on the inner circumferential surface of the blocking bush (180) so that the discharge disk cannot play rightward or leftward, and the discharge disk comprises a semi-circle-like discharge hole (141) formed through the disk in the central portion thereof.

In this way, the water introduced to the mixing hole (132) formed in the central portion of the selection/mixing disk (130) can be guided in the discharge direction.

Furthermore, the blocking/path selection disk (150) of the present invention is a circular block which is brought into close contact with one side face of the discharge disk (140), on one side face of which are symmetrically formed 90 degree arc-like direct water path guide hole (151) and shower path guide hole (152) opposite the semi-circle-like discharge hole (141) formed in the central portion of the discharge disk (140), and on parts of the both sides of the outer circumferential edge of the other side face of which are formed fitting grooves (153) which are fastened to the flow amount-adjusting member.

In this way, at ordinary times the direct water path guide hole (151) and shower path guide hole (152) of the blocking/path selection disk (150) block the discharge of the water while being not aligned with the semi-circle-like discharge hole (141) formed in the central portion of the discharge disk (140), but guide the water to the direct water path or the shower path, depending on rightward or leftward rotated state.

At this point, the amount of the direct water or the shower is adjusted according to the angle of rightward or leftward rotation.

At this point, the direct water path guide hole (151) and the shower path guide hole (152) may be formed lager in the form of semi-circle on the other side.

Furthermore, the flow amount-adjusting member (160) of the present invention is a pipe through which are formed separately inside the pipe a direct water path (161) and a shower path (162) corresponding to the direct water path guide hole (151) and the shower path guide hole (152) of the blocking/path selection disk (150), respectively, and on the outer circumferential surface of one end portion of the member are projectedly formed a stopper (164) of 90 degrees of angle, degree of rotation angle of which is limited, and on the outer circumferential surface of the side of the member adjoining the blocking/path selection disk (150) are formed projected pieces (165) for fastening to the blocking/path selection disk (150), and a packing (166) is inserted on the side of the member adjoining the blocking/path selection disk (150).

At this point, the direct water path (161) may extend from one end to the other end of the flow amount-adjusting member (160), and the shower path (162) may divert its course midway between the two ends of the flow amount-adjusting member (160) toward the outer circumferential surface to extend to the side surface via a shower guide hole (163).

Furthermore, the water temperature-adjusting member (170) of the present invention is a pipe which is fitted coaxial with the flow amount-adjusting member (160) while being isolated from the flow amount-adjusting member (160) by a blocking bush (180) inserted and fixed in the cartridge housing (190) and is fittedly coupled with the selection/mixing disk (130) to be rotationally operated, and one end portion of the member is extended in the form of flange to form lateral extension pieces (171), and at end portion of the lateral extension pieces (171) may be formed fitting projected portions (172) fastened to the selection/mixing disk (130).

In this way, rotational operation can be made without interference with the flow amount-adjusting member (160), and the lateral extension pieces (171) are limited in degree of rotation angle by projected pieces (191) projectedly formed on the inner circumferential surface of the cartridge housing (190), thereby rotated rightward and leftward in a constant range of angle (90 degrees of angle rightward and leftward, respectively) and cause the selection/mixing disk (130) fastened to the end portion of the water temperature-adjusting member to be rotated.

Furthermore, in the blocking bush (180) of the present invention, on the outer circumferential surface of one end portion of the blocking bush are formed fixing projections (181) engaging with a pair of projected pieces (191) and preventing play, each of the projected pieces being formed on the both sides of the inner circumferential surface of the cartridge housing (190) perpendicularly thereto, and fixing projected portions (182) are formed on the end portion on which the fixing projections (181) are formed, the fixing projected portions being fittedly assembled to the discharge disk (140), and on the other end portion may be formed rotation guide groove (183) which limits rotation angle of the flow amount-adjusting member (160).

At this point, the rotation guide groove (183) may be formed in the range of 270 degrees of angle.

In this way, the stopper (164) of the flow amount-adjusting member (160) corresponds to the rotation guide groove (183) and is rotationally operated rightward and leftward only within 90 degrees of angle.

In this way, the discharge of the water is blocked or the water can be discharged through the communication of the direct water path or the shower path, depending on the state where the blocking/path selection disk (150) rotated while being fastened to the flow amount-adjusting member (160) is rotated to communicate with the discharge hole (141) of the discharge disk (140).

The operation of the present invention constructed as above is described as follows.

First, in the present invention, such a case is described as a basic state of ordinary times that the selection hole (131) of the selection/mixing disk (130) is positioned so that the selection hole opens the both of the cold water hole (121) and the hot water hole (122) of the separation/introduction disk (120), as shown in FIG. 4 of the attached drawings.

In the state as described above, both of the cold water and the hot water are introduced, and water thus obtained by mixing of the cold water and the hot water is introduced into the central mixing hole (132) of the selection/mixing disk (130) and guided to the discharge hole (141) of the discharge disk (140).

At this point, if the selection/mixing disk (130) is rotated leftward or rightward, namely in the direction of the cold water hole (121) or the hot water hole (122), as shown in FIGS. 5 and 6 of the attached drawings, the cold water or the hot water introduced into the cold water hole (121) or the hot water hole (122) is introduced into the selection hole (131) and guided to the discharge hole (141) via the mixing hole (132).

At this point, at the time of mixing of the cold water and the hot water, the water temperature can be adjusted according to ratio of the opened and closed area of the cold water hole (121) and the hot water hole (122), though not illustrated in the drawings.

Here, the rotational operation of the selection/mixing disk (130) is made possible by the water temperature-adjusting member (170) fittedly fastened to the projected portions (133), and the water temperature-adjusting member (170) is operated by the water temperature-adjusting knob (2) described above.

As described above, depending on the open and closed states of the cold/hot water holes (121)(122) of the separation/introduction disk (120) and the selection hole (131) of the selection/mixing disk (130), the cold water or the hot water or the mixed water (water temperature-adjusted) is guided to the discharge hole (141) of the discharge disk (140), as shown in FIG. 7 of the attached drawings, or blocking surface of the blocking/path selection disk (150), namely the surface other than the direct water path guide hole (151) and the shower path guide hole (152) blocks the discharge hole (141), therefore the water is not discharged out of the valve cartridge (100).

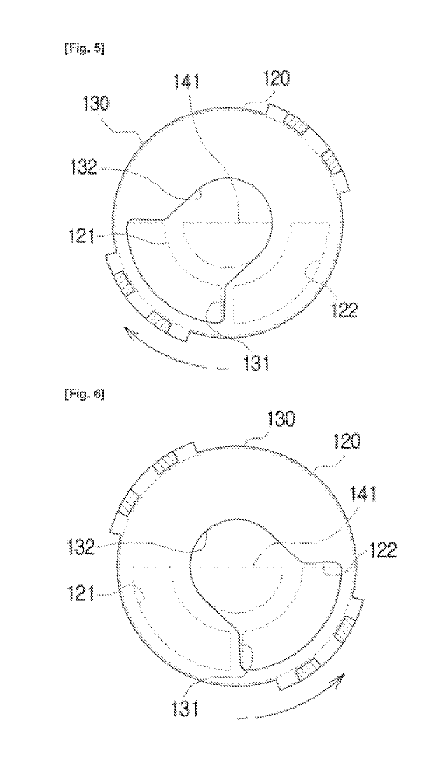

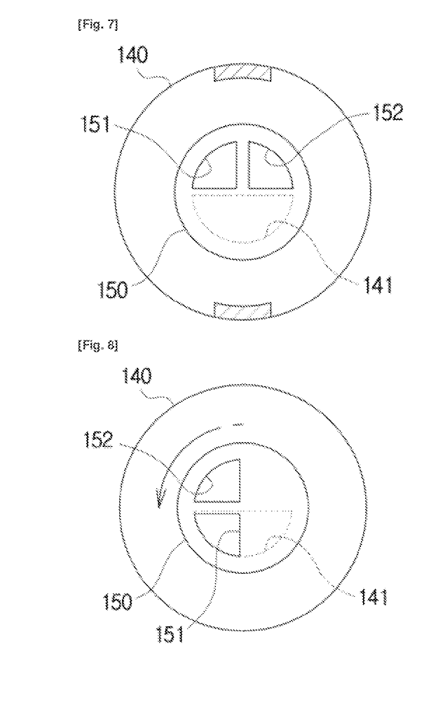

At this point, if the blocking/path selection disk (150) is rotated leftward, that is to say, the direct water path guide hole (151) is aligned with the discharge hole (141) of the discharge disk (140), the water is discharged to the direct water path, as shown in FIG. 8 of the attached drawings, and the flow amount discharged to the direct water path is adjusted according to the ratio of the aligned area.

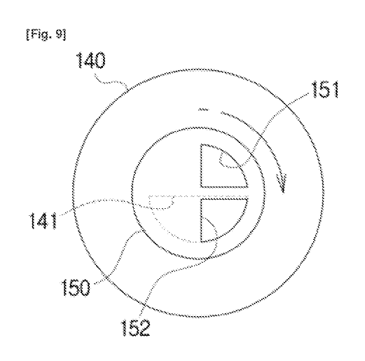

Furthermore, if the blocking/path selection disk (150) is rotated rightward, that is to say, the shower path guide hole (152) is aligned with the discharge hole (141) of the discharge disk (140), the water is discharged to the direct water path, as shown in FIG. 9 of the attached drawings, and the flow amount discharged to the direct water path is adjusted according to the ratio of the aligned area.

Here, the rotational operation of the blocking/path selection disk (150) is made possible by the rotational operation of the flow amount-adjusting member (160) since the blocking/path selection disk (150) is fastened to the projected piece (165) of the flow amount-adjusting member (160), and the flow amount-adjusting member (160) is operated by the flow amount-adjusting knob (1) described above.

In this way, if the direct water path or the shower path is selected by the rotational operation of the blocking/path selection disk (150), the water is injected and discharged through the direct water path (161) or the shower path (162) formed in the flow amount-adjusting member (160) to the corresponding injection hole of the outlet port (12), namely the direct water hole (12a) or the shower hole (12b).

As described above, in the present invention, the selection of the direct water path or the shower path or the adjustment of the flow amount of the selected path as well as the opening and closing operation can be made solely through the operation of the flow amount-adjusting member (160), thereby the realization of various functions is possible with simple structure and operations.

Furthermore, in the present invention, the water valve (10) and the injection port head are integrated, thereby the structure is simple and the installation place is not disordered and is treated simply

As stated above, the present invention has been described and illustrated with a preferred example showing principles of the present invention for example, but the present invention is not limited to the constructions and the operations as it is, illustrated and described as above.

Rather, the persons skilled in the art will understand that various changes and modifications of the present invention is possible without deviating from concept and scope of the attached claims.

Therefore, such all appropriate changes, modifications and equivalents should be considered to fall within the scope of the present invention.

1. A water valve comprising a valve cartridge which adjusts amount and temperature of supplied cold/hot water so as to discharge it, characterized in that the valve cartridge comprises a separation/introduction disk for separating and introducing the cold/hot water; a selection/mixing disk which is stacked on one side face of the separation/introduction disk and selects and mixes the cold/hot water through rightward and leftward rotational operation; a discharge disk which is stacked on one side face of the selection/mixing disk and guides water introduced from the selection/mixing disk in a discharge direction; a blocking/path selection disk which is stacked on one side face of the discharge disk and blocks the discharge of the water or guides the water to a direct water path or a shower path through the rightward and leftward rotational operation; a flow amount-adjusting member, one end portion of which is fastened to one side face of the blocking/path selection disk and the other end portion of which is exposed to the outside, and to the exposed circumferential surface of which is fastened a flow amount-adjusting knob, so that the water is discharged directly or in a shower only in a state that the blocking/path selection disk is opened by rotational operation of the flow amount-adjusting knob; a water temperature-adjusting member, one end portion of which is fastened to one side face of the selection/mixing disk and the other end portion of which is exposed to the outside, and to the exposed circumferential surface of which is fastened a water temperature-adjusting knob, so that the selection/mixing disk is rotated by rotational operation of the water temperature-adjusting knob; a blocking bush, one end portion of which is fastened to one side face of the discharge disk to form a sealed space, and the other end portion of which is brought into close contact with a circumferential surface of one end portion of the flow amount-adjusting member to limit a rotation angle of the flow amount-adjusting member; a cartridge base which accommodates the separation/introduction disk to prevent rotational play; and a cartridge housing which is fastened to the cartridge base to accommodate all the components described above, and limits rotation angle of the water temperature-adjusting member.

2. (canceled)

3. The water valve according to claim 1, characterized in that the flow amount-adjusting knob is fitted on the outer circumferential surface of the flow amount-adjusting member with the inner circumferential surface of the knob being in a angled state, and the water temperature-adjusting knob is also fitted on the outer circumferential surface of the water temperature-adjusting member with the inner circumferential surface of the knob being in a angled state.

4. The water valve according to claim 1, characterized in that the flow control section is part which the discharge disk and the blocking/path selection disk adjoin, the discharge disk guiding the introduced water in the discharge direction, and the blocking/path selection disk being stacked on one side face of the discharge disk and blocking the discharge of the water or guiding the water to the direct water path or the shower path through the rightward and leftward rotational operation.

5. The water valve according to claim 1, characterized in that the valve cartridge is inserted and fixed inside a valve body connected with cold/hot water pipes such that only end portions of the flow amount-adjusting member and the water temperature-adjusting member are exposed to the outside.

6. The water valve according to claim 1, characterized in that the end portions of the flow amount-adjusting member exposed to the outside of the valve cartridge is connected with an outlet port for discharging the water being discharged to a direct water hole in central portion or a shower hole in outer side portion.

7. The water valve according to claim 1, characterized in that the central portion of the outlet port is fitted with end portion of the flow amount-adjusting member, and the outer circumferential surface of the outlet port is fixed by screwing to the inner surface of one end portion of the flow amount-adjusting knob.

8. The water valve according to claim 1, characterized in that the flow amount-adjusting knob and the water temperature-adjusting knob are arranged in the form of ring between the valve body and the outlet port.

9. The water valve according to claim 1, characterized in that separation/introduction disk is a circular plate-like disk, one side face of which is partially accommodated in the cartridge base to be fixed therein, and arc-like cold/hot water holes are provided symmetrically in the half parts of the separation/introduction disk, respectively.

10. The water valve according to claim 9, characterized in that the arc-like cold/hot water holes are formed in the range of 180 degrees of angle.

11. The water valve according to claim 1, characterized in that the selection/mixing disk is a circular plate-like disk which is brought into close contact with one side face of the separation/introduction disk, and comprises a selection hole formed in the central part and a arc-like mixing hole having arc-angle of 90 degrees which is formed by outward extension from the selection hole, and a plurality of projected portions which are projected on the both sides of the outer circumferential surface of the disk to define grooves, thus fasten the disk on one end portion of the water temperature-adjusting member.

12. The water valve according to claim 1, characterized in that the discharge disk is a circular plate-like disk which is brought into close contact with one side face of the selection/mixing disk and a part of the outer circumferential surface of which is fitted on the inner circumferential surface of the blocking bush so that the discharge disk cannot play rightward or leftward, and the discharge disk comprises a semi-circle-like discharge hole formed through the disk in the central portion thereof.

13. The water valve according to claim 1, characterized in that the blocking/path selection disk is a circular block which is brought into close contact with one side face of the discharge disk, on one side face of which are symmetrically formed 90 degree arc-like direct water path guide hole and shower path guide hole opposite the semi-circle-like discharge hole formed in the central portion of the discharge disk, and on parts of the both sides of the outer circumferential edge of the other side face of which are formed fitting grooves which are fastened to the flow amount-adjusting member.

14. The water valve according to claim 13, characterized in that the direct water path guide hole and the shower path guide hole are formed lager in the form of semi-circle on the other side.

15. The water valve according to claim 1, characterized in that the flow amount-adjusting member is a pipe through which are formed separately inside the pipe a direct water path and a shower path corresponding to the direct water path guide hole and the shower path guide hole of the blocking/path selection disk, respectively

16. The water valve according to claim 1, characterized in that on the outer circumferential surface of one end portion of the flow amount-adjusting member are projectedly formed a stopper of 90 degrees of angle, degree of rotation angle of which is limited, and on the outer circumferential surface of the side of the member adjoining the blocking/path selection disk are formed projected pieces for fastening to the blocking/path selection disk, and a packing is inserted on the side of the member adjoining the blocking/path selection disk.

17. The water valve according to claim 15, characterized in that the direct water path is extend from one end to the other end of the flow amount-adjusting member.

18. The water valve according to claim 15, characterized in that the shower path diverts its course midway between the two ends of the flow amount-adjusting member toward the outer circumferential surface to extend to the side surface via a shower guide hole.

19. The water valve according to claim 1, characterized in that the water temperature-adjusting member is a pipe which is fitted coaxial with the flow amount-adjusting member while being isolated from the flow amount-adjusting member by a blocking bush inserted and fixed in the cartridge housing and is fittedly coupled with the selection/mixing disk to be rotationally operated, and one end portion of the member is extended in the form of flange to form lateral extension pieces, and at end portion of the lateral extension pieces are formed fitting projected portions fastened to the selection/mixing disk.

20. The water valve according to claim 1, characterized in that in the blocking bush, on the outer circumferential surface of one end portion of the blocking bush are formed fixing projections engaging with a pair of projected pieces and preventing play, each of the projected pieces being formed on the both sides of the inner circumferential surface of the cartridge housing perpendicularly thereto, and fixing projected portions are formed on the end portion on which the fixing projections are formed, the fixing projected portion being fittedly assembled to the discharge disk, and on the other end portion is formed rotation guide groove which limits rotation angle of the flow amount-adjusting member.

21. The water valve according to claim 20, characterized in that the rotation guide groove is formed in the range of 270 degrees of angle.
